(19) United States
(12) Patent Application Publication
(10) Pub. No.: US 2003/0110089 A1
(43) Pub. Date: Jun. 12, 2003

(54) Global business to business exchange

(76) Inventors: Roberto Villani, New York, NY (US); Alberto Piatti, Appiano Gentile (IT)

Correspondence Address: SKJERVEN MORRILL LLP, 25 METRO DRIVE, SUITE 700, SAN JOSE, CA, 95110, US

(21) Appl. No.: 10/014,067

(22) Filed: Dec. 10, 2001

(51) Int. Cl. G06F 17/60

(52) U.S. Cl. 705/26

(57) ABSTRACT

A business to business (B2B) exchange is provided that includes a web server. The web server includes multiple showrooms and order services. Each seller has at least one showroom to market his merchandise to multiple buyers. Order services receive and process orders for merchandise purchased by a buyer. The use of the web server enables the sellers to utilize just-in-time manufacturing in which smaller lots of merchandise are constantly produced, enabling continuous delivery rather than infrequent large shipments. Just-in-time manufacturing allows sellers to respond to market demands and trends, as well as modify styles mid-season or introduce new styles. The B2B exchange provides multiple services such that the amount of resources required for a buyer and a seller to establish and maintain multiple relationships is reduced, enabling business expansion opportunities for both. The B2B exchange provides relationship building services, marketing and order placement services, and transaction enabling services.

### BACKGROUND OF THE INVENTION

1. Field of the Invention

The present invention relates to the field of business to business (B2B) transactions and more particularly providing services via a web server to enhance the B2B capability of a business utilizing just-in-time manufacturing.

2. Description of the Related Art

Business to business (B2B) transactions typically involve the exchange of goods or merchandise from one business to another. The goods conveying business, referred to as a seller, is typically a manufacturer of the goods. The goods receiving business, referred to as a buyer, either resells the goods to another business (acting as a wholesaler) or resells the goods directly to consumers (acting as a retailer).

FIG. 1A illustrates a traditional buyer and seller relationship in a B2B environment. A seller 110 typically markets and sells his merchandise to multiple buyers 120(1)-(N). Merchandise can include apparel, accessories, home furnishings and any other type of goods. In this relationship, seller 110 markets his merchandise to each of buyers 120(1)-(N) individually through, for example, direct contact or a catalog, or seller 110 markets his merchandise to a group of buyers 120(1)-(N) through, for example, a fashion show. Thus, depending on the size of the operations and resources of seller 110, the number of buyers 120(1)-(N) to which seller 110 can market his goods is limited. In addition, seller 110 typically can offer new fashions only once or twice a year, for example, spring and fall. The limited offering keeps seller 110's marketing costs low. A small seller typically cannot market his merchandise to a large number of buyers and typically only sells locally and seasonally. Expansion for a small seller requires a large investment in time and resources to expand the market for his merchandise.

FIG. 11B illustrates another traditional buyer and seller relationship. A buyer 160 buys merchandise from multiple sellers 170(1)-(N). In this relationship, buyer 160 typically establishes an ongoing relationship with each of sellers 170(1)-(N). Buyer 160 typically requires a reasonable level of assurance that the goods are well made, of quality materials, delivered on time and in the correct manner, and at a good price. The resources required of buyer 160 to establish and maintain such a relationship can be great and often leads buyer 160 to purchase goods from only a limited number of sellers 170(1)-(N). Purchasing goods from a limited number of sellers can be an effective cost cutting measure, however, this often results in reduced product differentiation. In addition, buyers are limited to buying seasonally or a few times a year as sellers make new fashions available. Although this reduces buyer overhead, this also leads to reduced product differentiation.

Small sellers are limited in the number of buyers to which the sellers can market and the number of times per year new merchandise can be introduced and marketed, leading to limited opportunity for expansion. Buyers are limited in the number of sellers from which the buyers can purchase goods and are limited to buying seasonally, leading to limited product differentiation.

### SUMMARY OF THE INVENTION

In accordance with the present invention, a business to business (B2B) exchange is provided that includes a web server. The web server includes multiple showrooms and order services. Each seller has at least one showroom to market his merchandise to multiple buyers. Order services receive and process purchase requests for merchandise from the buyers. The use of the web server enables the sellers to utilize just-in-time manufacturing in which smaller lots of merchandise are constantly produced, enabling continuous delivery rather than infrequent large shipments. Just-in-time manufacturing allows sellers to respond to market demands and trends, as well as modify styles mid-season or introduce new styles.

The B2B exchange enables multiple sellers to sell merchandise and goods to multiple buyers. The B2B exchange provides multiple services such that the amount of resources required for a buyer and a seller to establish and maintain multiple relationships is reduced, enabling business expansion opportunities for both. Sellers are given the ability to market and sell merchandise to an unlimited number of buyers without resource limitations. Buyers are given the ability to buy merchandise from an unlimited number of sellers without resource limitations. The B2B exchange provides relationship building services, marketing and order placement services, and transaction enabling services. The B2B exchange provides a complete B2B solution, meeting the needs of both sellers and buyers.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIGS. 1A-1B, shown as prior art, illustrate traditional buyer and seller relationships in a business to business (B2B) environment.

FIG. 2 illustrates a B2B exchange that provides an improved relationship between buyers and sellers in a B2B environment according to embodiments of the present invention.

FIG. 3 illustrates relationship building services 232 provided by B2B exchange 230 according to embodiments of the present invention.

FIG. 4 illustrates marketing and order placement services 234 provided by B2B exchange 230 according to embodiments of the present invention.

FIGS. 5A-5C illustrate showroom services 410 provided by B2B exchange 230 according to embodiments of the present invention.

FIGS. 6A-6C illustrate order services 420 provided by B2B exchange 230 according to embodiments of the present invention.

FIGS. 7A-7D illustrate transaction enabling services 236 provided by B2B exchange 230 according to embodiments of the present invention. The use of the same reference symbols in different drawings indicates similar or identical items.

### DETAILED DESCRIPTION

The following is intended to provide a detailed description of an example of the invention and should not be taken to be limiting of the invention itself. Rather, any number of variations may fall within the scope of the invention that is defined in the claims following the description.

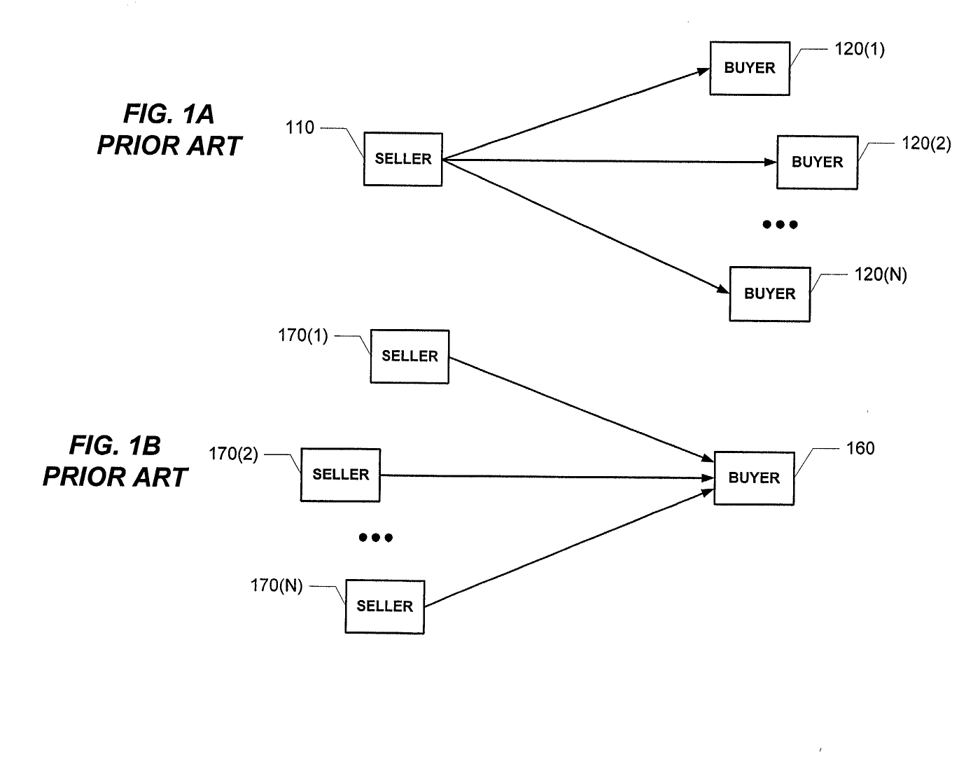

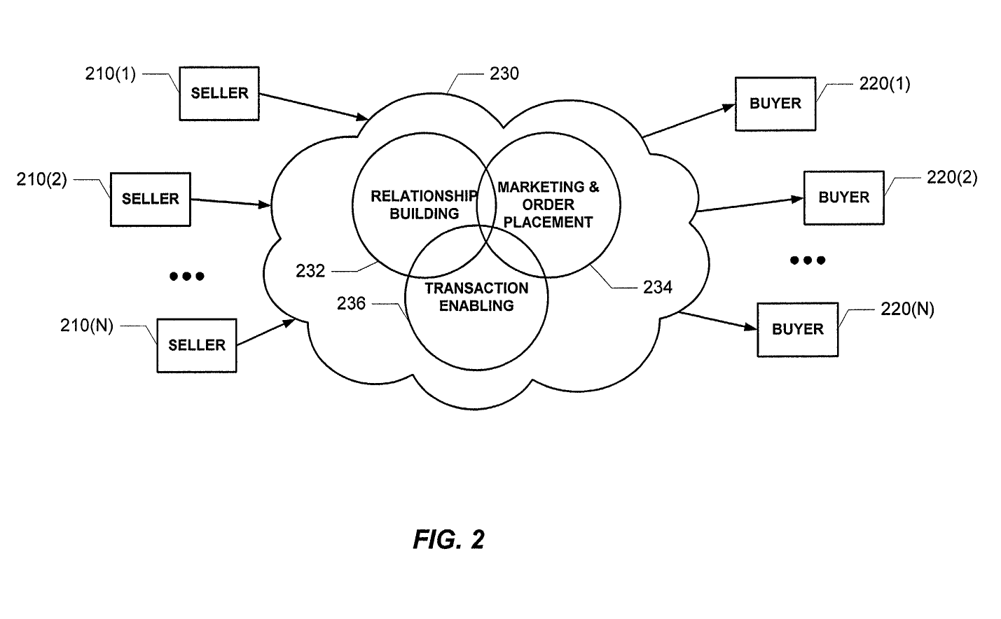

FIG. 2 illustrates a business to business (B2B) exchange that provides an improved relationship between buyers and sellers in a B2B environment according to embodiments of the present invention. Multiple sellers 210(1)-(N) sell merchandise to multiple buyers 220(1)-(N) through the use of a B2B exchange 230. B2B exchange 230 utilizes, among other mechanisms, a web server to provide multiple services such that the amount of resources required for buyers 220(1)-(N) and sellers 210(1)-(N) to establish and maintain multiple relationships is reduced, enabling business expansion opportunities for both. Sellers 210(1)-(N) are given the ability to market and sell merchandise to an unlimited number of buyers 220(1)-(N) without the limitations as described in the relationship of FIG. 1A. Buyers 220(1)-(N) are given the ability to buy merchandise from an unlimited number of sellers 210(1)-(N) without the limitations as described in the relationship of FIG. 1B.

In addition, sellers 210(1)-(N) can continuously update merchandise available for sale, removing the seasonal limitations of traditional B2B relationships. B2B exchange 230 also offers buyers 220(1)-(N) a way to buy on the Internet that is effective by utilizing “just-in-time” manufacturing. Just-in-time manufacturing is a manufacturing technique whereby smaller lots are constantly produced, enabling continuous delivery rather than infrequent large shipments. This manufacturing technique allows sellers 210(1)-(N) to respond to market demands and trends, as well as modify styles mid-season or introduce new styles. For buyers 220(1)-(N), the shorter delivery cycle of just-in-time manufacturing means quicker response to market reactions, smaller inventories, and fewer markdowns.

B2B exchange 230 provides a spectrum of services for both sellers 210(1)-(N) and buyers 220(1)-(N) that permit e-commerce via a web server between businesses that are typically strangers to one another. B2B exchange 230 provides relationship building services 232, marketing and order placement services 234, and transaction enabling services 236. B2B exchange 230 provides a complete B2B solution, meeting the needs of both sellers 210(1)-(N) and buyers 220(1)-(N).

The services provided by B2B exchange 230 can be internally or externally provided. Internal services are typically those that are delivered by B2B exchange 230 personnel and/or web server directly. Internal services include, for example, seller certification, market consulting, training and operational support, and marketing promotion. External services are those services which are generally delivered by outsource partners. External services include, for example, imaging, logistics, shipping, fulfillment, customs, payment processing, and returns. By providing a complete array of services, whether internally or externally delivered, B2B exchange 230 enables sellers 210(1)-(N) to easily and conveniently expand the market for their goods and allows buyers 220(1)-(N) to provide product differentiation at no additional risk or resource cost.

It will be noted that the variable identifier “N” is used in several instances in FIG. 2 and other figures to more simply designate the final element (e.g., seller 210(N), buyer 220(N), and so on) of a series of related or similar elements (e.g., sellers 210(1)-(N), buyers 220(1)-(N), and so on). The repeated use of such variable identifiers is not meant to imply a correlation between the sizes of such series of elements. The use of such variable identifiers does not require that each series of elements have the same number of elements as another series delimited by the same variable identifier. Rather, in each instance of use, the variable identified by “N” can hold the same or a different value than other instances of the same variable identifier. For example, seller 210(N) may be the ninth seller in a series of sellers, whereas buyer 220(N) may be the forty-sixth buyer in a series of buyers.

It is also noted that FIG. 2 illustrates relationship building services 232, marketing and order placement services 234, and transaction enabling services 236 as overlapping each other. Those skilled in the art will recognize that the boundaries between services are merely illustrative and alternative embodiments may merge services or impose an alternative decomposition of functionality of services. For example, the services discussed herein may be decomposed into sub-services to be executed as multiple processes. Moreover, alternative embodiments may combine multiple instances of a particular service or sub-service. Furthermore, those skilled in the art will recognize that the operations described in exemplary embodiment are for illustration only. Operations may be combined or the functionality of the operations may be distributed in additional operations in accordance with the invention.

Relationship Building

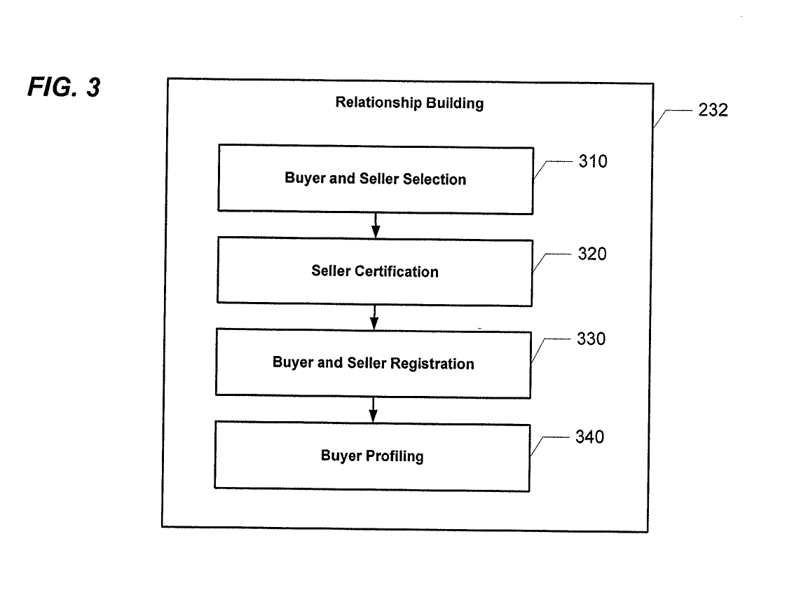

FIG. 3 illustrates relationship building services 232 provided by B2B exchange 230 according to embodiments of the present invention. Relationship building services 232 include buyer and seller selection 310, seller certification 320, buyer and seller registration 330, and buyer profiling 340.

To provide relationship building services 232, B2B exchange 230 provides services that increase the knowledge and trust of sellers 210(1)-(N) by buyers 220(1)-(N), and knowledge and preferences of buyers 220(1)-(N) by sellers 210(1). For example, B2B exchange 230 actively matches sellers and buyers together utilizing information gathered about the merchandise of a particular seller and the requirements of a buyer.

Buyers are selected and profiled to actively match buyers with appropriate sellers and attempt to create new trading partnerships. Sellers are selected and certified to ensure reliability. Seller certification involves an analysis of the seller's type of production, level of fiscal health, and whether the seller adheres to international standards of safety and accepted employment practices. Seller certification is an on-going process, involving ongoing on-site inspections, questionnaires and other documentation, in which each seller is classified according to their capabilities and competencies. Re-certification is typically conducted annually, or more often if performance standards are not met. Buyers and sellers are registered to provide secure access to B2B exchange 230 and showrooms on the web server.

Marketing Order and Placement

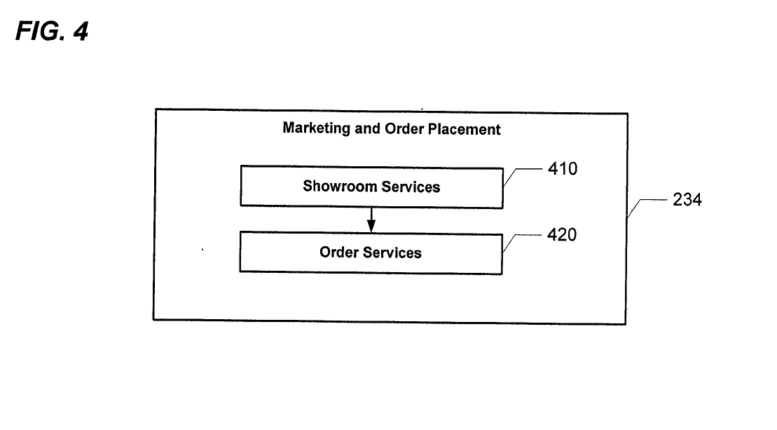

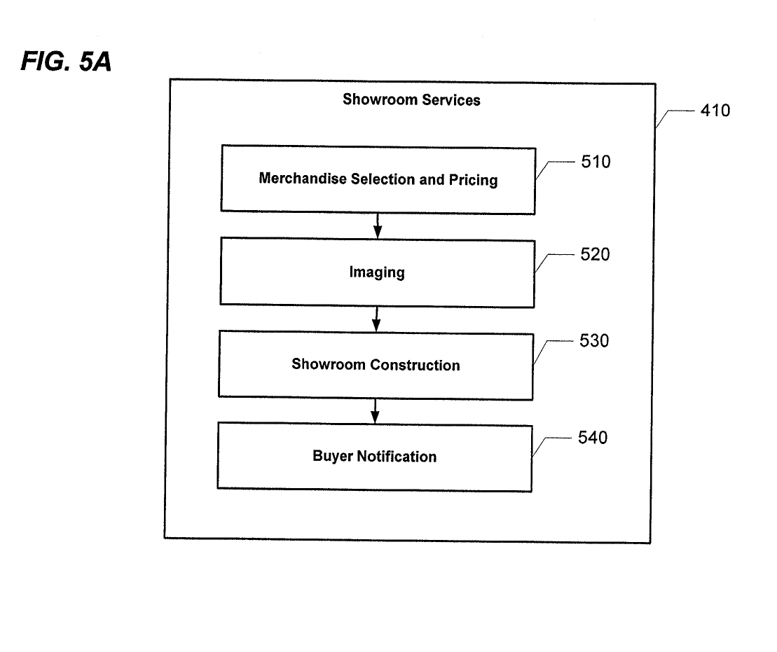

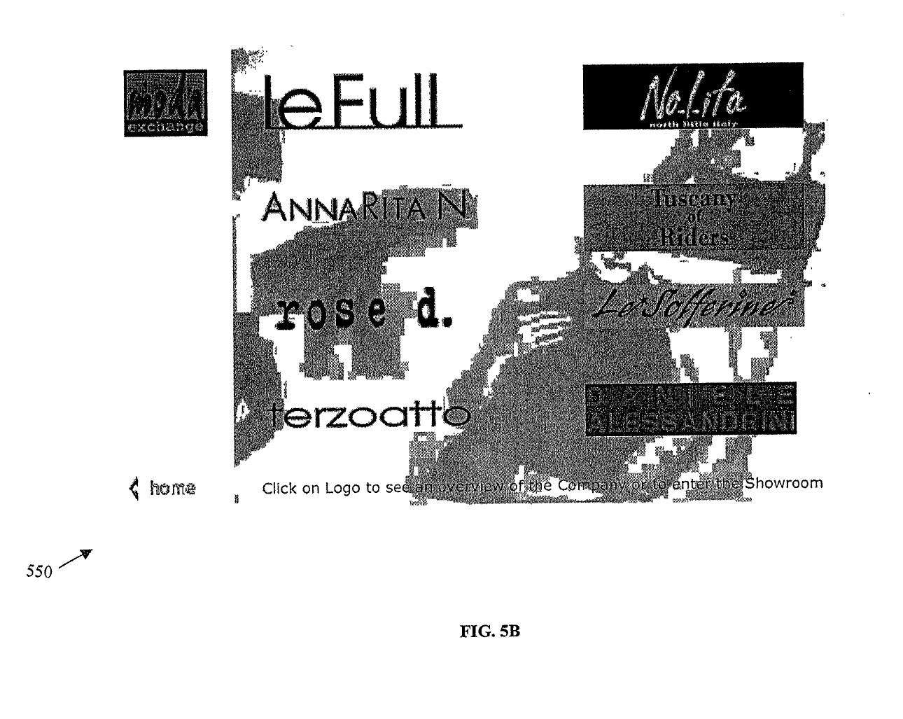

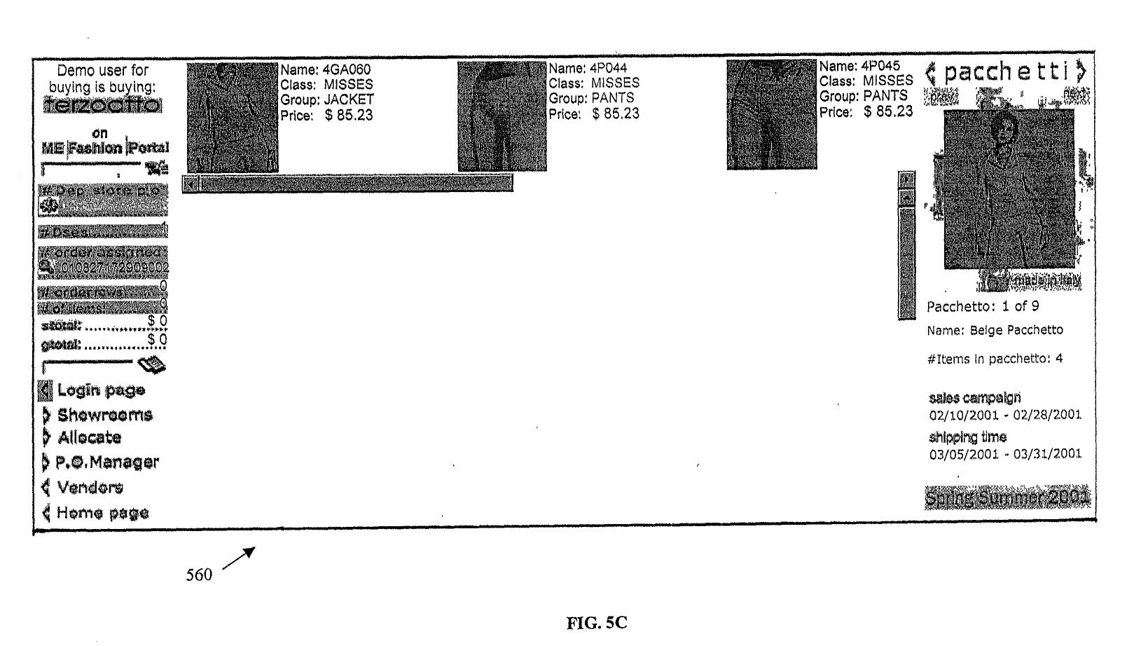

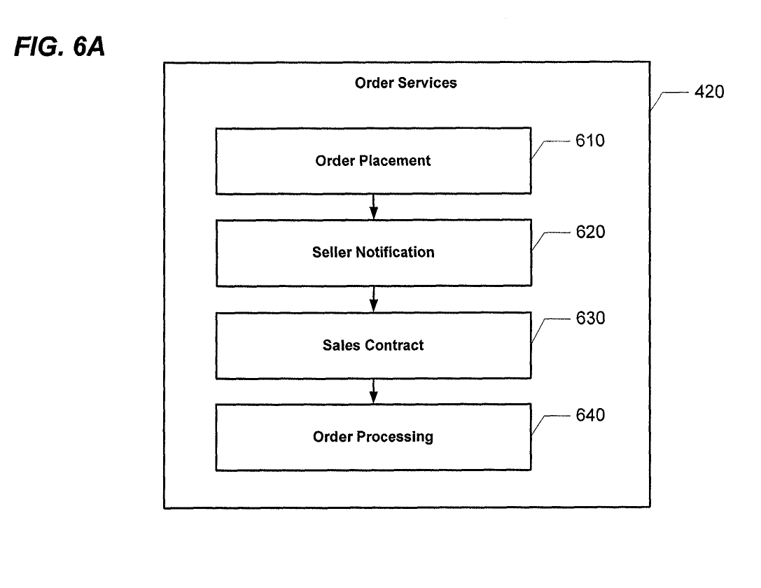

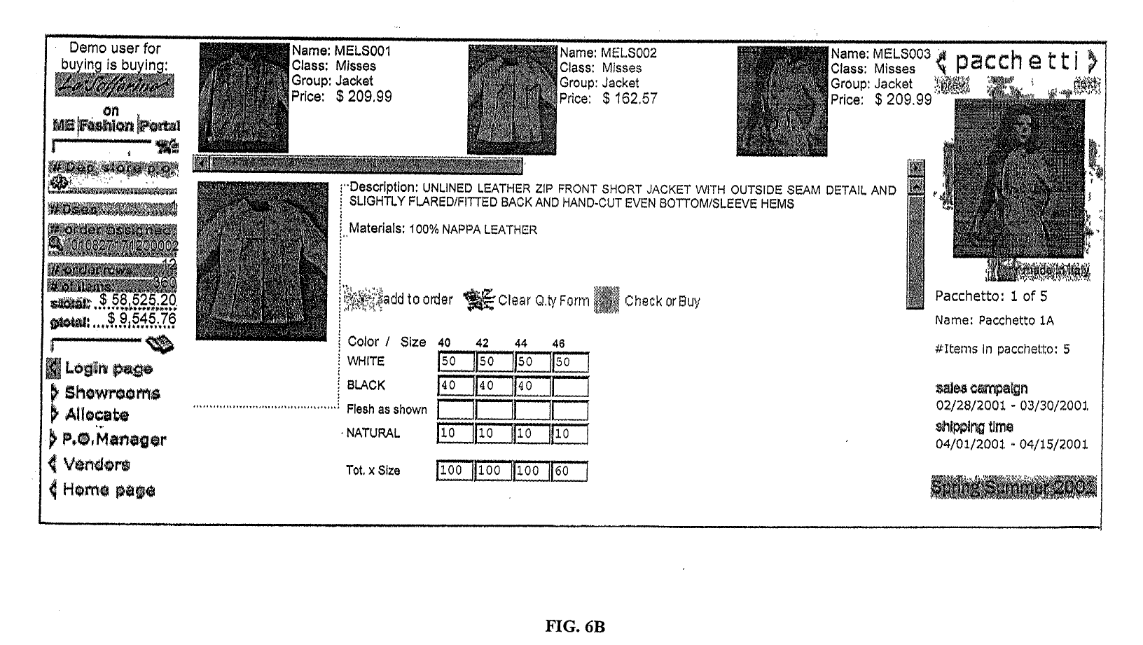

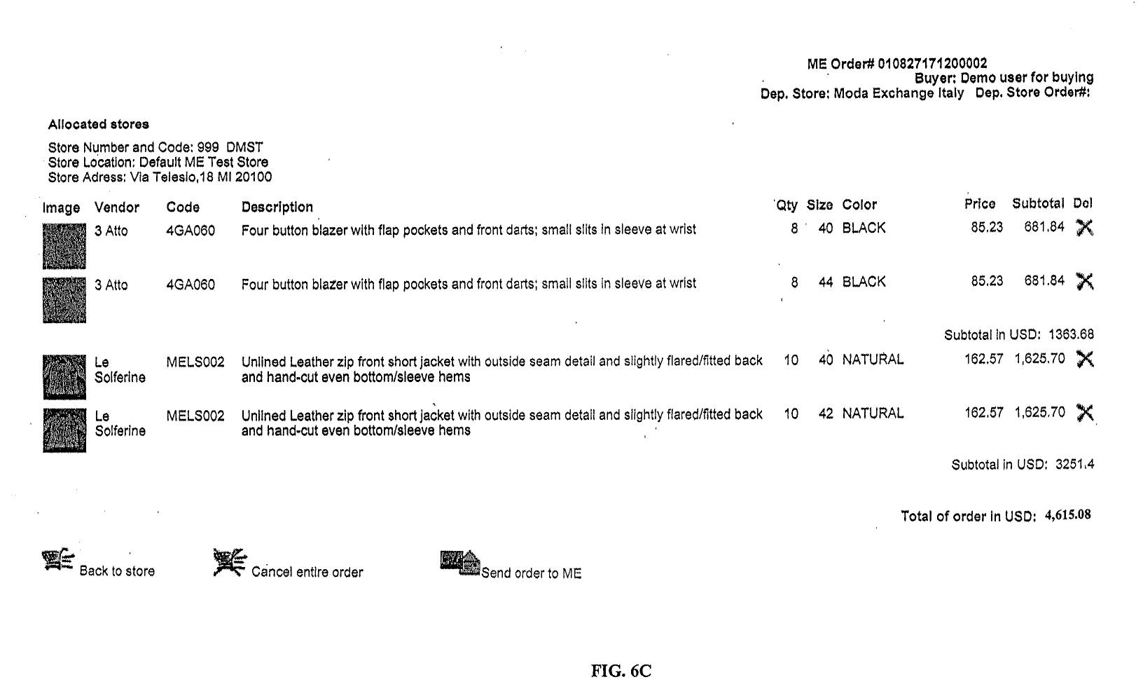

FIG. 4 illustrates marketing and order placement services 234 provided by B2B exchange 230 according to embodiments of the present invention. Marketing and order placement services 234 includes showroom services 410 and order services 420. Showroom services are further described in FIGS. 5A-5C. Order services 420 are further described in FIGS. 6A-6C.

To provide marketing and order placement services 234, B2B exchange 230 utilizes the Internet and a web server for the flow of information between buyers 220(1)-(N) and sellers 210(1)-(N). The web server provides a forum for sellers 210(1)-(N) to market their merchandise to multiple buyers 220(1)-(N) without increased resources required for each additional buyer.

In addition, sellers 210(1)-(N) can continuously update merchandise available for sale, removing the seasonal limitations of traditional B2B relationships. B2B exchange 230 also offers buyers 220(1)-(N) a way to buy on the Internet that is effective by utilizing “just-in-time” manufacturing. Just-in-time manufacturing is a manufacturing technique whereby smaller lots are constantly produced, enabling continuous delivery rather than infrequent large shipments. This manufacturing technique allows sellers 210(1)-(N) to respond to market demands and trends, as well as modify styles mid-season or introduce new styles. For buyers 220(1)-(N), the shorter delivery cycle of just-in-time manufacturing means quicker response to market reactions, smaller inventories, and fewer markdowns.

FIG. 5A illustrates showroom services 410 provided by B2B exchange 230. Showroom services 410 include merchandise selection and pricing 510, imaging 520, showroom construction 530, and buyer notification 540.

B2B exchange 230 can provide sellers 210(1)-(N) with critical information concerning the market of buyers 220(1)-(N), for example, information regarding sizing information, pricing considerations, and differences in taste and style that affect merchandise selection. Each of sellers 210(1)-(N) can have one or more showrooms, accessible to buyers 220(1)-(N) through the web server. Each showroom can be designed to have a similar look and feel by adhering to a standardized format. For example, the standardized format utilizes photograph, product description and web page presentation criteria. By utilizing standard criteria for photographs of merchandise and description information, buyers 220(1)-(N) can use the exchange to buy from multiple sellers 210(1)-(N) in a streamlined and easy to use fashion. In addition, B2B exchange 230 can provide technical and artistic standards for the display of merchandise in each digital showroom. B2B exchange 230 can assist sellers 210(1)-(N) in the selection of images and the construction of a showroom. In addition, B2B exchange 230 can provide an approved list of photographers who provide digital imaging services for sellers who do not have appropriate images for use in a showroom.

FIG. 5B illustrates a web page 550. Buyers 220(1)-(N) are presented with a choice of sellers 210(1)-(N), represented by the seller's logo, on web page 550. By clicking on a logo, a buyer can enter the showroom of a particular seller. FIG. 5C illustrates an exemplary showroom 560. Showroom 560 exhibits multiple items from which a buyer can select. Photographs and descriptions of merchandise are presented in a uniform format across merchandise and showrooms, providing a buyer with a familiar and easy to use forum to purchase goods from multiple sellers.

FIG. 6A illustrates order services 420 provided by B2B exchange 230. Order services 420 includes order placement 610, seller notification 620, sales contract 630, and order processing 640. Utilizing a web server, one of buyers 220(1)-(N) can browse showrooms, select merchandise to purchase, and place an order.

An exemplary web page to place an order is illustrated in FIG. 6B. Orders can be placed for merchandise from multiple sellers in one session. FIG. 6C illustrates an exemplary order status including purchases from multiple sellers. Each of the multiple sellers is notified, typically through the use of the Internet for speedier transactions, sales contracts are issued, and the order is processed.

By use of a web server and just-in-time manufacturing, merchandise offered by sellers 210(1)-(N) can be continuously updated, removing the seasonal limitations of traditional B2B relationships. Buyers 220(1)-(N) are not limited to seasonal buying. The use of the Internet provides an easy to use, familiar mechanism for buyers 220(1)-(N) to purchase merchandise while eliminating the need for travel. Just-in-time manufacturing allows sellers 210(1)-(N) to respond to market demands and trends, as well as modify styles mid-season or introduce new styles. For buyers 220(1)-(N), the shorter delivery cycle of just-in-time manufacturing means quicker response to market reactions, smaller inventories, and fewer markdowns.

Transaction Enabling

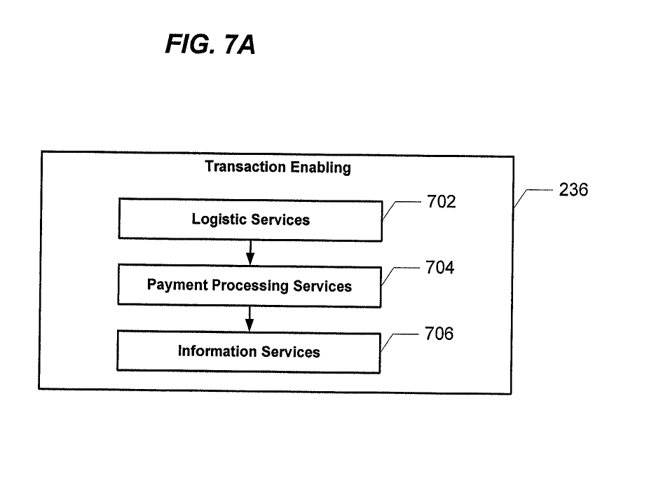

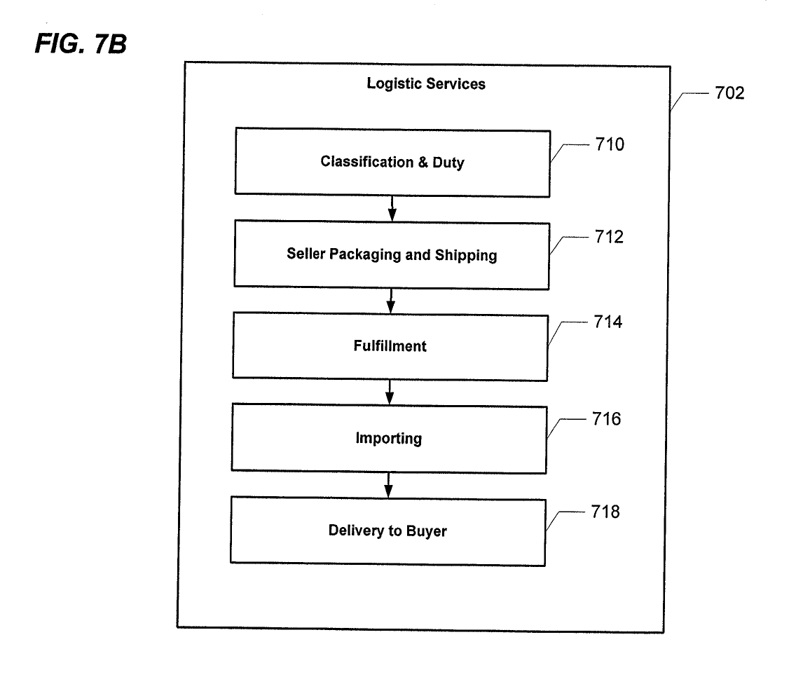

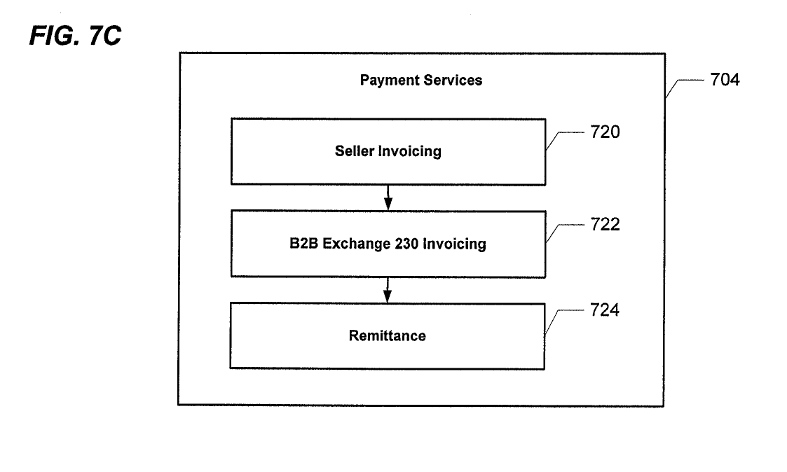

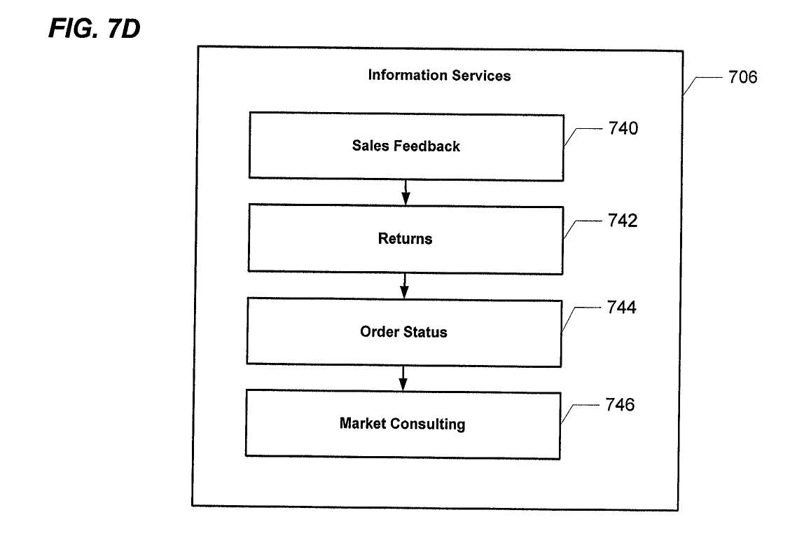

FIG. 7A illustrates transaction enabling services 236 provided by B2B exchange 230 according to embodiments of the present invention. Transaction enabling services 236 include logistic services 702, further described in FIG. 7B, payment processing services 704, further described in FIG. 7C, and information services 706, further described in FIG. 7D.

To provide transaction enabling services 236, B2B exchange 230 provides services for order and payment processing, shipping and packaging logistics, and the like. A small seller or one who is not experienced in international sales does not have the infrastructure to support international transactions. In addition, by providing uniform transactions across multiple sellers, a buyer can become confident to engage in transactions with sellers with whom the buyer has not previously dealt.

FIG. 7B illustrates logistic services 702 provided by B2B exchange 230. Logistic services 702 includes classification and duty services 710, seller packaging and shipping 712, fulfillment services 714, importing 716, and delivery to buyer 718.

B2B exchange 230 provides services to external warehousers, fulfillment centers, and quality assurance firms in the country of the seller. These external logistics systems tie to shipment tracking systems of B2B exchange 230 to continue the flow of information after the merchandise has left the control of a seller. B2B exchange 230 provides services to external fulfillment houses in the country of the buyer that provide “floor-ready” shipments.

B2B exchange provides international shipping, customs and fulfillment services. A team of shipment companies, such as transoceanic shippers, air cargo shippers, and small-package rapid shipment companies for samples provide shipping services. Customs services, via a customs broker, is also available for venders.

FIG. 7C illustrates payment processing services 704 provided by B2B exchange 230. Payment processing services 704 includes seller invoicing 720, B2B exchange 230 invoicing 722, and remittance 724.

B2B exchange 230 provides payment services by collaborating with international financial institutions to offer traditional as well as progressive finance possibilities. These institutions provide buyer financial certification, letters of credit or credit systems, electronic funds transfer, forms of transaction insurance and credit card transactions.

FIG. 7D illustrates information services 706 provided by B2B exchange 230. Information services 706 includes sales feedback 740, returns 742, order status 744, and market consulting 746. By gathering information about buyers needs, market trends, and the like, B2B exchange 230 can be more effective in enabling relationships between sellers 210(1)-(N) and buyers 220(1)-(N). Through the use of a web server, order status and returns can be tracked.

B2B exchange 230 provides buyers 220(1)-(N) with a reduced-risk, fast and reliable forum to buy merchandise from multiple sellers 210(1)-(N). Buyers 220(1)-(N) can achieve product differentiation resulting from using new sellers and as sellers update merchandise selections. Transactions are conducted utilizing the efficiency of the Internet. Utilizing buyer feedback, merchandise can be made appropriate for each buyer including style, sizing, and assortment. Aggregating volume creates economies of scale. Financial transactions are streamlined. By certifying sellers, buyers have a reasonable level of assurance that the product will be well-made, of quality materials, delivered on-time and in the correct manner, and at a good price. For medium or small chains and large single buyers, B2B exchange 230 creates the possibility of seeing new, first-of-season or mid-season merchandise (not closeout) on a continuous basis that is not available to them unless they invest in a costly global network of buyers. For large chains, B2B exchange 230 creates the possibility to compete with more nimble specialty stores that have the ability to bring new, current fashion merchandise to the retail floor in very short time frames. Sellers 210(1)-(N) offer ready-to-ship or short production cycle merchandise in quantities and assortments that accommodate the volume required by large chains.

B2B exchange 230 provides a reduced risk, targeted, easy, and efficient forum to sellers 210(1)-(N) to market and sell merchandise to multiple buyers 220(1)-(N). Sellers 210(1)-(N) are provided with the information needed to do business and satisfy each buyer. A buyer database permits a seller to know what relevant buyers want and how they want it. A network of account managers for buyers and sellers reduces the costs and risks of developing new markets and new buyers. B2B exchange 230 provides a spectrum of services that enable an apparel manufacturer to conduct B2B e-commerce in another country, regardless of that manufacturer's knowledge of the other country's market or the technological sophistication of the manufacturer.

Through the use of a web server and just-in-time manufacturing, merchandise offered by sellers 210(1)-(N) can be continuously updated, removing the seasonal limitations of traditional B2B relationships. Just-in-time manufacturing allows sellers 210(1)-(N) to respond to market demands and trends, as well as modify styles mid-season or introduce new styles. For buyers 220(1)-(N), the shorter delivery cycle of just-in-time manufacturing means quicker response to market reactions, smaller inventories, and fewer markdowns. The use of the Internet provides an easy to use, familiar mechanism for buyers 220(1)-(N) to purchase merchandise while eliminating the need for travel.

Other embodiments are within the following claims. Also, while particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A business to business (B2B) exchange comprising:
a web server configured to enable a plurality of buyers to purchase merchandise from a plurality of sellers; wherein the web server comprises:
one or more showrooms for each of the plurality of sellers to market the merchandise to the plurality of buyers; and
order services configured to receive and process purchase requests for the merchandise from the plurality of buyers.

2. The B2B exchange as recited in claim 1, wherein the web server is configured to enable just-in-time manufacturing where smaller lots of merchandise are manufactured continuously and offered for sale.

3. The B2B exchange as recited in claim 1, wherein each of the plurality of sellers is certified.

4. The B2B exchange as recited in claim 1, wherein each of the one or more showrooms adheres to a standardized format.

5. The B2B exchange as recited in claim 1, further comprising:
showroom services, wherein the showroom services comprise:
merchandise selection and pricing;
imaging;
showroom construction; and
buyer notification.

6. The B2B exchange as recited in claim 1, further comprising:
order services, wherein the order services comprise:
order placement;
seller notification;
sales contract; and
order processing.

7. A method of providing a business to business (B2B) exchange comprising:
certifying and registering a plurality of sellers;
registering a plurality of buyers;
providing a web server wherein
each of the plurality of sellers can display merchandise for sale,
each of the plurality of buyers can browse the merchandise for sale, and
each of the plurality of buyers can place orders to purchase the merchandise for sale.

8. The method as recited in claim 7, wherein the web server is configured to enable just-in-time manufacturing where smaller lots of merchandise are manufactured continuously and offered for sale.

9. A method of providing a business to business (B2B) exchange comprising:
providing a variety of services that enable a plurality of sellers to sell merchandise to a plurality of buyers by providing relationship building services, marketing and order placement services, and transaction enabling services.

10. The method as recited in claim 9, wherein the providing a variety of services utilizes a web server configured to enable just-in-time manufacturing where smaller lots of merchandise are manufactured continuously and offered for sale.

11. A method of providing a variety of business to business (B2B) services comprising:
providing match-making services between the plurality of sellers and the plurality of buyers;
providing a showroom for each of the plurality of sellers to market merchandise to the plurality of buyers;
providing an ability to receive orders from the plurality of buyers; and
providing for payment processing for each of the orders.

12. The method as recited in claim 11, further comprising utilizing a web server configured to enable just-in-time manufacturing where smaller lots of merchandise are manufactured continuously and offered for sale.

13. The method as recited in claim 11, wherein providing match-making services comprises:
selecting the plurality of buyers and the plurality of sellers;
certifying each of the plurality of sellers;
registering each of the plurality of buyers and each of the plurality of sellers; and
profiling each of the plurality of buyers.

14. The method as recited in claim 11, wherein providing the showroom comprises:
aiding each of the plurality of sellers in selecting and pricing merchandise;
providing imaging services to one or more of the plurality of sellers that do not have imaging capability; and
aiding each of the plurality of sellers in showroom construction.

15. The method as recited in claim 11, wherein providing the ability to receive orders from the plurality of buyers comprises:
providing a web service that allows order placement from the plurality of buyers;
notifying one or more of the plurality of sellers of an order placement; and
processing the orders.

16. The method as recited in claim 11, wherein providing for payment processing comprises:
invoicing each of the plurality of sellers; and
collecting payment for merchandise from each of the plurality of buyers.

17. The method as recited in claim 11, wherein the providing the variety of services further comprises:
providing logistic services.

18. The method as recited in claim 11, wherein the providing logistic services comprises:
handling classification and duty services for merchandise;
aiding the plurality of sellers in packaging and shipping merchandise;
aiding the plurality of sellers in importing merchandise.

19. The method as recited in claim 11, wherein the providing the variety of services further comprises:
compiling information.

20. The method as recited in claim 11, wherein the compiling information comprises:
gathering sales feedback;
providing order status; and
providing market consulting information.
